(19) United States
(12) Patent Application Publication
(10) Pub. No.: US 2012/0130991 A1
(43) Pub. Date: May 24, 2012

(54) HYBRID APPROACH TO FEDERATED SEARCH

(75) Inventors: Yusuf Atas, Redmond, WA (US); Jingqian Zhao, Redmond, WA (US); Roland Saad, Redmond, WA (US); Christopher Sanders, Redmond, WA (US)

(73) Assignee: MICROSOFT CORPORATION, Redmond, WA (US)

(21) Appl. No.: 12/950,162

(22) Filed: Nov. 19, 2010

(51) Int. Cl. G06F 17/30

(52) U.S. Cl. 707/722; 707/769; 707/E17.014

(57) ABSTRACT

Techniques to provide a hybrid federated search are described. A web server may receive a search query from a client and select an immediate search source to perform the search. A script may be generated that causes the client to re-send the search query for a delayed search source. The script may execute on the client when the client displays the results from the immediate search source. Other embodiments are described and claimed.

### BACKGROUND

Providing a central point from which to search multiple independent search sources has many challenges. Server-based solutions may be constrained to wait for all search results to return before being able to present the results to the requesting client. Server-based solutions may also consume too many server resources. Client-based solutions may not work if scripting is disabled. Client-based solutions may also “break” if search sources change their interfaces. Search sources may not wish to expose their business logic to client-based solutions, as doing so may make the search source more vulnerable to malicious attacks. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to provide a hybrid approach for a federated search. In one embodiment, for example, a technique may comprise receiving a search query from a client and selecting either an immediate search source or a delayed search source. In either case, the search may be formatted according to the search source's configuration and sent to the search source. When an immediate search source is used, typically when the search is first received, results from the search are provided to the client along with a script for the client to run. When the client receives the results, if scripting is enabled, the client will run the script. Running the script causes the search query to be sent again, and upon receipt, the delayed search sources may be used. In this way, the client may receive at least some results faster, regardless of whether scripting is enabled. When the script is run, the client may receive additional results, without having to wait for all of the results. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a system for performing a federated search.

FIG. 2 illustrates an embodiment of a web server to provide a federated search.

FIG. 3 illustrates an embodiment of a logic flow for performing a federated search.

FIG. 4 illustrates an embodiment of a second logic flow for performing a federated search.

FIG. 5 illustrates an embodiment of a computing architecture.

FIG. 6 illustrates an embodiment of a communications architecture.

### DETAILED DESCRIPTION

Various embodiments are directed to performing a search of multiple search sources, a federated search, by using both a server component and a client component. Some embodiments may use a server component to search some search sources immediately, and to generate a script for the client to run to initiate the search from other sources in a delayed fashion. Embodiments may allow the client to receive at least some results more quickly, while providing the ability to receive more results in a delayed manner, and without exposing business logic to the clients. Further, if the client component is not operative, the client may still receive at least some results.

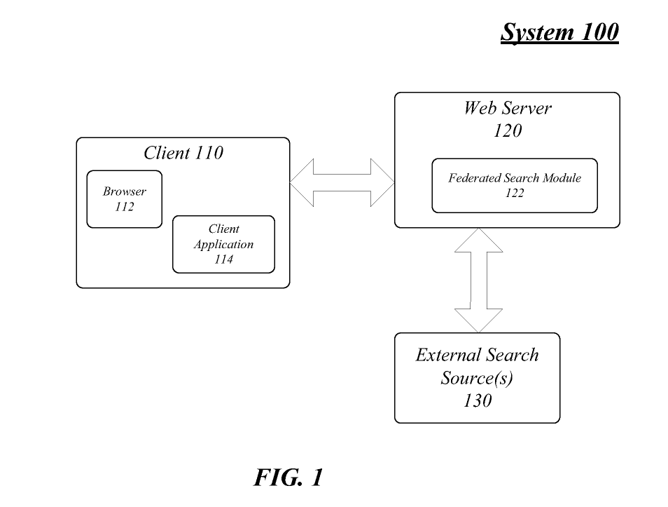

FIG. 1 illustrates a block diagram for a system 100 to provide a federated search. In one embodiment, for example, the system 100 may comprise a computer-implemented system 100 having multiple components, such as client 110, web server 120, and external search sources 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components of system 100 may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In various embodiments, the system 100 may comprise client 110. Client 110 may be a computing device, such as, but not limited to, a desktop computer, a laptop computer, a tablet computer, a smart phone, a portable digital assistant, etc. Client 110 may have a browser 112 and/or a client application 114. Browser 112 may be operative on client 110 to display and interact with web sites. Client application 114 may be any application operative on client 110 that provides the ability to search for information. For example, client application 114 may be a word processing application that allows the user to search via a “help” feature. Client application 114 may be a “help” or “search” feature of the operating system on client 110, rather than a stand-alone application. Client application 114 may be browser 112. The embodiments are not limited to these examples.

In various embodiments, the system 100 may comprise web server 120. Web server 120 may provide the federated search service described herein. In an embodiment, web server 120 may include a federated search module 122 operative on web server 120 to provide the functionality. Web server 120 may receive search queries from client 120 and may select one or more immediate search sources and send appropriately formatted searches to the immediate search sources. Web server 120 may reserve some search sources for searching later if a delayed search is initiated by client 110, as will be described in more detail below.

In various embodiments, the system 100 may comprise external search sources 130. External search sources 130 may be external to web server 120 in the sense that they may operate physically and/or logically on different servers from web server 120. External search sources 130 may also be operated independently, for example, by a different entity than the one that operates web server 120. External search sources 130 may each have their own search configuration that defines the way in which a search of that search source should be structured and formatted. External search sources 130 may include, for example, online help sources, user forums, original equipment manufacturer (OEM) support sources, knowledgebase sources, internal corporate support sources, etc.

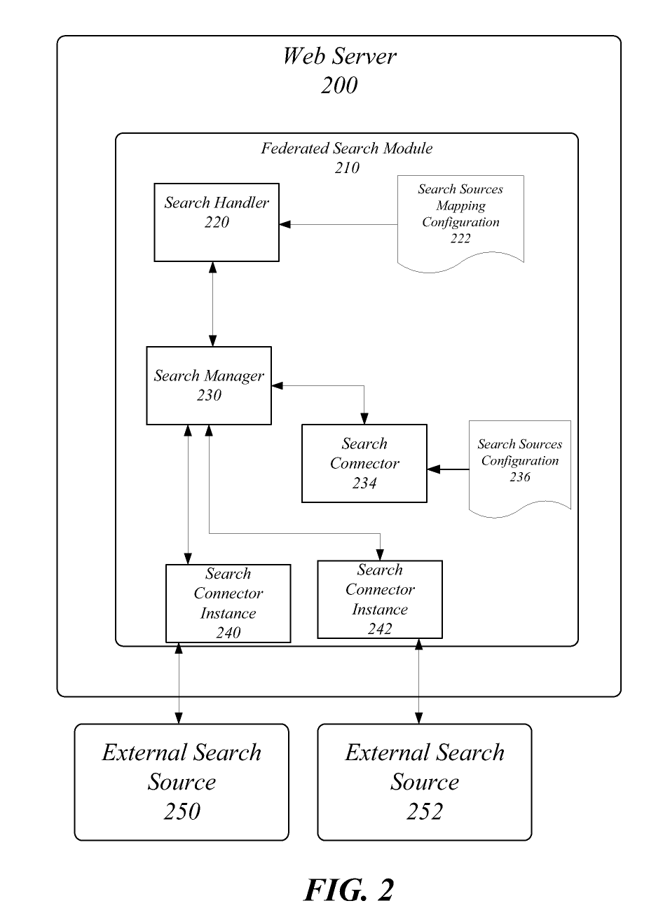

FIG. 2 illustrates a block diagram of a web server 200 to provide a federated search. Web server 200 may be an example of web server 120. Web server 200 may include a federated search module 210, which may be an example of federated search module 122. Federated search module 210 may include one or more components to implement its functionality. In various embodiments, federated search module 210 may comprise, for example, a search handler 220 and a search manager 230.

Search handler 220 may receive search queries from clients, such as client 110. Search handler 220 may select one or more external search sources to search, and may use search sources mapping configuration 222 to determine which search sources are immediate search sources and which are delayed search sources. Search handler 220 may also format results returned from an external search source such that the results may be displayed on the client, for example, in HTML. Search handler 220 may also generate a script to be run by the client. If scripting is enabled on the client, the script may run when the client displays the search results. The script causes the client to send the search query to web server 200 again to be serviced by delayed search sources.

Search sources mapping configuration 222 may be a configurable list of search sources designated as “immediate” or “delayed” search sources. A search source may be designated dynamically as immediate or delayed depending, for example, on client, server, and/or search source performance.

Search sources may be designated as immediate for specific client applications or application types. For example, an operating system help-generated search may be best served by online help for that operating system. The search source for that operating system may therefore be designated as immediate. For the same operating system help search, however, a general search source may be less relevant, and may be designated as a delayed search source. Similarly, a search query coming from a game or a productivity application may be best served by a search source hosted by the manufacturer of the application.

In the interest of providing relevant results in as short a time as possible, some search sources with known slower response times may be designated as delayed search sources. In some embodiments, the host of web server 200 may have partnerships with some search source providers and may designate those partner sites as immediate search sources.

Search manager 230 may receive the search query from search handler 220 along with the selected search sources. Search manager 230 may look up the search configurations for the selected search sources. For example, search manager 230 may provide the selected search sources and the search query to search connector 234. Search connector 234 may read search sources configuration 236 to determine which search connector to use for a search source. Search connector 234 may create an object or an instance of a search connector, e.g. search connector instance 240 or 242, that includes the search query formatted specifically for a particular search source. If more than one search source is selected, then one search connector instance may be created for each source. Search connector 234 may provide the search connector instance to search manager 230, which may then send the search connector instance to its external search source. For example, search connector instance 240 may be sent to external search source 250, and search connector instance 242 may be sent to external search source 252.

Search manager 230 may receive results and use search connector 234 to process the results from the external search source into a format for use by search handler 220, such as, for example, a really simple syndication (RSS) format. If results are received from more than one source, search manager 230 may aggregate the results for search handler 220.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

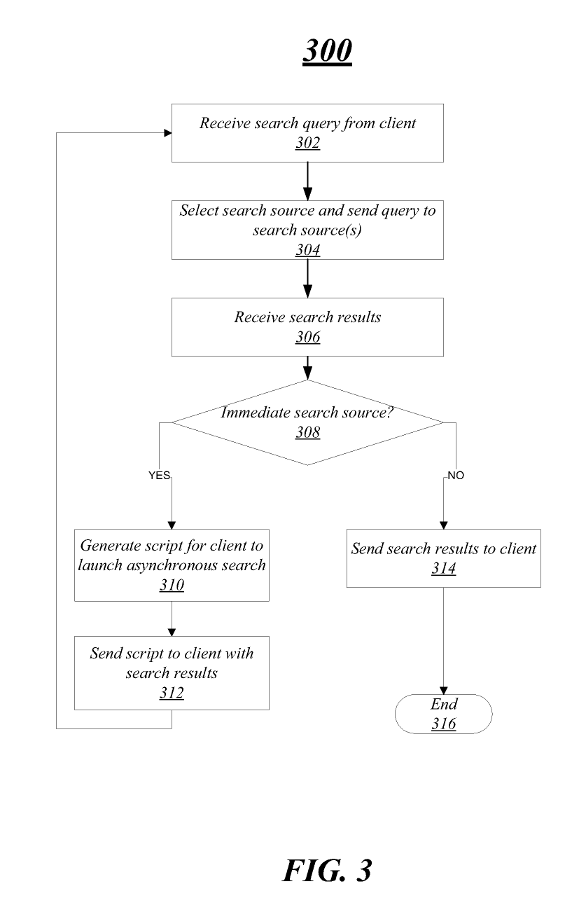

FIG. 3 illustrates one embodiment of a logic flow 300. The logic flow 300 may be representative of some or all of the operations executed by one or more embodiments described herein.

In the illustrated embodiment shown in FIG. 3, the logic flow 300 may receive a search query from the client at block 302. For example, web server 200 may receive an original search query from the client, or may receive a search query from a script previously provided by federated search module 122.

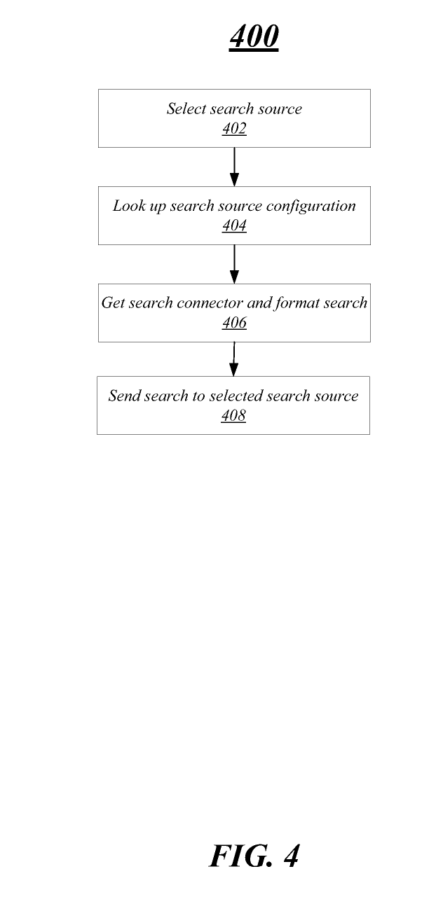

The logic flow 300 may select a search source and send the query to the search source at block 304. For example, search handler 220 may select an immediate or a delayed search source. Search manager 230 may format the search query for the search source and send the formatted search query to the selected search source. Block 304 is described in more detail in FIG. 4 below.

The logic flow 300 may receive the search results at block 306. For example, search results may be returned by the external search sources in the format used by the external search source. Search manager 230 may use the configuration information known about the external search source by search connector 234 to read and format the search results into a format for search handler 220. For example, the search results may be formatted into RSS format, XML, etc.

If more than one external search source was selected, then receiving search results may include waiting for search results from all of the selected external search sources, then aggregating the search results together in the format expected by search handler 220, e.g. RSS, prior to providing the results to search handler 220. Search manager 230 may perform the aggregation, and may perform any error handling as necessary. In some embodiments, providing the search results to search handler 220 may release the server resources used for the search so that the resources, e.g. threads, may be used by another search.

The logic flow 300 may determine whether the external search source was an immediate search source at block 308. If the external search source was an immediate search source, then search handler 220 may generate a script for the client to run, at block 310. The script may be written, for example, in JavaScript, or any scripting language that the client can execute. In an embodiment, the script may instead be a stand-alone application that the client application can cause to begin executing, or an application-dependent set of instructions, such as an applet.

When executed, the script may cause the client to re-send the search query for searching on delayed search sources. The query sent by the script may contain a selection of one or more delayed search sources to use. The query sent by the script may contain a flag to indicate that the search is being re-sent and that delayed search sources should be used but selected dynamically. Other means for indicating that the search query comes from the script, as opposed to being a new search query, may be used.

In some embodiments, the determination in block 308 may take place at other parts of logic flow 300, and/or may occur in parallel with other parts of logic flow 300, such as when the immediate search sources are selected.

The logic flow 300 may send the script to the client with the search results at block 312. For example, search handler 220 may format the search results for display at the client, for example, into HTML for display in a web browser, or in an application-specific format, such as for a help application.

When the client displays the search results it receives from search handler 220, the client may execute the script. When the script is executed, the client may send a new search query for the delayed search sources, and the logic flow may return to block 302 for processing the delayed search. In this manner, the client may receive at least some results quickly.

If the search source was not an immediate search source at block 308, then the search results may be sent to the client at block 314. As in block 312, sending the search results from the delayed search may include formatting the search results for display at the client.

The logic flow 300 may end at block 316. In an embodiment (not shown), if the script is not executed by the client, logic flow 300 may end at block 316 after block 314. The script may not be run, for example, if scripting is disabled on the client.

FIG. 4 illustrates one embodiment of a logic flow 400. The logic flow 400 may be representative of some or all of the operations executed by one or more embodiments described herein. In particular, logic flow 400 may be an embodiment of block 304 from FIG. 3.

In the illustrated embodiment shown in FIG. 4, the logic flow 400 may select the search source at block 402. For example, search handler 220 may use search mapping configuration 222 to identify one or more search sources for the search query. As described above, search mapping configuration 222 may be configurable dynamically. While some search sources may be designated as immediate search sources, if network conditions are poor, or a particular search source is not responsive, an immediate search source may be dynamically designated as being a delayed search source. Likewise, if network conditions improve, a search source becomes responsive again, or other performance criteria change, a delayed search source may be dynamically designated as immediate.

In an embodiment, search handler 220 may select a search source based on the content of the query or the client application that sent the query. For example, if the client application was an operating system help search, e.g. “no sound”, search handler 220 may select online help sources for that operating system. If, instead, the search was from a web browser, e.g. “best LCD TV”, search handler 220 may select a more general search source.

When a search query is received for the first time, one or more immediate search sources may be selected, as appropriate for the query. When the search query is received as a result of the previously-sent script, then delayed search sources may be selected. The delayed search sources selected may be specified in the search query, or may be chosen dynamically.

The logic flow 400 may look up search source configurations for the selected search sources at block 404. Search manager 230 may load any general configurations that it needs, such as time-out parameters. Search manager 230 may call search connector 234 to get the appropriate search configuration for a selected search source. Search connector 234 may look in search sources configuration 236 for the requested search configuration. Providing the search source configuration to search manager 230 may include, for example, pointing to a function header that, when called or executed, will create an object of the selected search source configuration type. The embodiments are not limited to this example.

The logic flow 400 may create an instance of a search connector and format the search at block 406. Search manager 230 may use the search source configuration provided in block 404 to create an instance of a search connector specific to the selected external search source. The search connector instance may include the search query configured so as to be received and processed by the application program interface (API) provided by the selected external search source.

The logic flow 400 may send the formatted search query to the selected search source at block 408. For example, the search connector instance for that search source may send the search query to the search source. From block 408, flow may return to block 306 in FIG. 3.

In this way, clients do not need to have any knowledge of search source APIs, and do not have to stay up-to-date when APIs change. Similarly, search sources do not have to expose their APIs, except to web server 120, 200.

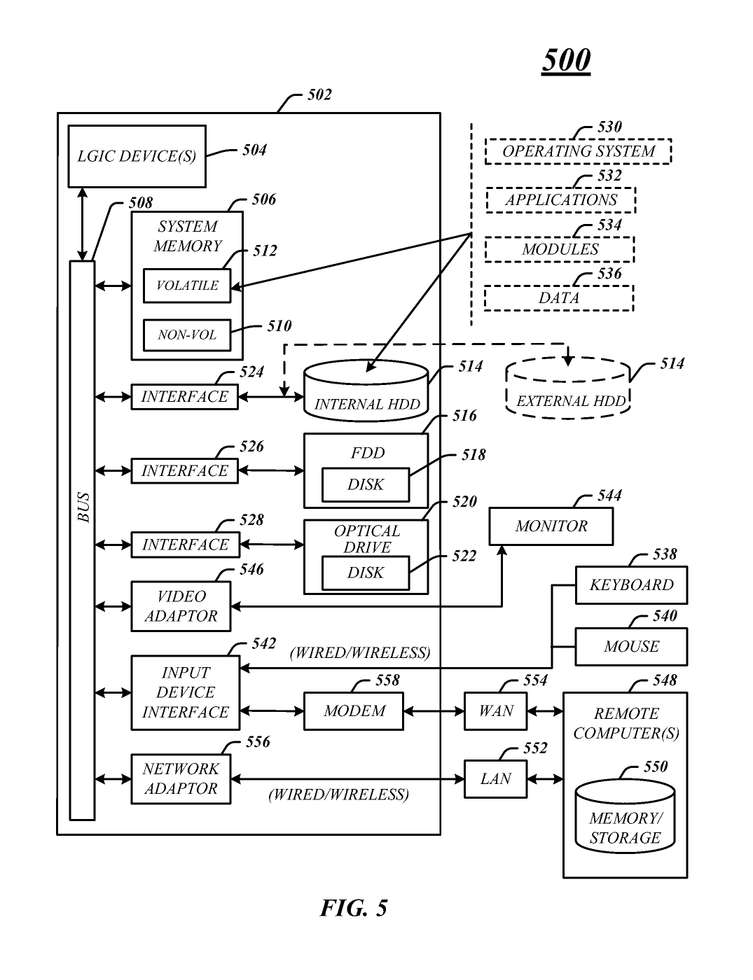

FIG. 5 illustrates an embodiment of an exemplary computing architecture 500 suitable for implementing various embodiments as previously described. The computing architecture 500 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 500.

As shown in FIG. 5, the computing architecture 500 comprises a logic device(s) 504, a system memory 506 and a system bus 508. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 504. The system bus 508 provides an interface for system components including, but not limited to, the system memory 506 to the logic device(s) 504. The system bus 508 can be any of several types of bus structure that may further interconnect to a memory bus (with or without a memory controller), a peripheral bus, and a local bus using any of a variety of commercially available bus architectures.

The system memory 506 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 5, the system memory 506 can include non-volatile memory 510 and/or volatile memory 512. A basic input/output system (BIOS) can be stored in the non-volatile memory 510.

The computer 502 may include various types of computer-readable storage media, including an internal hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536. The one or more application programs 532, other program modules 534, and program data 536 can include, for example, client application 114, federated search module 122, search handler 220 or search manager 230.

A user can enter commands and information into the computer 502 through one or more wire/wireless input devices, for example, a keyboard 538 and a pointing device, such as a mouse 540. Other input devices may include a microphone, an infra-red (IR) remote control, a joystick, a game pad, a stylus pen, touch screen, or the like. These and other input devices are often connected to the logic device(s) 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

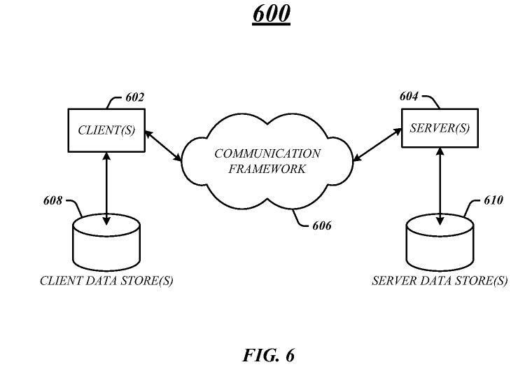

FIG. 6 illustrates a block diagram of an exemplary communications architecture 600 suitable for implementing various embodiments as previously described. The communications architecture 600 includes various common communications elements, such as a transmitter, receiver, transceiver, radio, network interface, baseband processor, antenna, amplifiers, filters, and so forth. The embodiments, however, are not limited to implementation by the communications architecture 600.

As shown in FIG. 6, the communications architecture 600 comprises includes one or more clients 602 and servers 604. The clients 602 may implement the client system 110. The servers 604 may implement the server system 120. The clients 602 and the servers 604 are operatively connected to one or more respective client data stores 608 and server data stores 610 that can be employed to store information local to the respective clients 602 and servers 604, such as cookies and/or associated contextual information.

The clients 602 and the servers 604 may communicate information between each other using a communication framework 606. The communications framework 606 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 602 and the servers 604 may include various types of standard communication elements designed to be interoperable with the communications framework 606, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 602 and a server 604 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure.

This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving a first search query from a client at a server;
selecting an immediate search source;
sending the search query to the immediate search source; and
returning search results from the immediate search to the client with a script that, when run, causes the client to send a second search query comprising the first search query.

2. The method of claim 1, wherein sending the search query to the immediate search source comprises:
retrieving a search configuration for the immediate search source;
formatting the search query according to the search configuration; and
sending the formatted search query to the immediate search source.

3. The method of claim 1, wherein returning search results from the immediate search comprises:
formatting the search results for display at the client.

4. The method of claim 1, wherein the script is run at the client when the search results are displayed on the client.

5. The method of claim 1, further comprising:
receiving the second search query from the client;
selecting a delayed search source;
sending the second search query to the delayed search source; and
returning search results from the delayed search source to the client.

6. The method of claim 5, wherein selecting a search source comprises selecting an immediate search source or a delayed search source from a configurable list of search sources.

7. The method of claim 6, further comprising:
dynamically changing a search source between being a delayed and an immediate search source according to at least one of server performance and client performance.

8. The method of claim 1, wherein at least one search source is independent of the server.

9. An article comprising a storage medium containing instructions that when executed cause the system to:
select an immediate search source in response to a first search query from a client;
send the search query to the immediate search source;
generate a script that, when run by the client, causes the client to send a second search query comprising the first search query; and
return search results from the immediate search to the client with the script.

10. The article of claim 9, wherein the instructions to send the search query to the immediate search source comprise instructions that when executed cause the system to:
retrieve a search configuration for the immediate search source;
format the search query according to the search configuration; and
send the formatted search query to the immediate search source.

11. The article of claim 9, further comprising instructions that when executed cause the system to:
receive search results from a plurality of immediate search sources;
aggregate the search results;
format the aggregated search results for display on the client; and
send the formatted search results with the script to the client.

12. The article of claim 9, further comprising instructions that when executed cause the system to:
select a delayed search source in response to receiving the second search query from the client;
send the second search query to the delayed search source; and
return search results from the delayed search source to the client.

13. The article of claim 9, wherein the instructions to select a search source further comprise instructions that when executed cause the system to:
select an immediate search source or a delayed search source from a configurable list of search source.

14. The article of claim 13, further comprising instructions that when executed cause the system to:
dynamically change a search source between being a delayed and an immediate search source.

15. An apparatus, comprising:
a logic device;
a communication interface; and
a federated search module executing on the logic device to:
select a search source in response to a search query from a client, wherein the selected search source is an immediate search source or a delayed search source;
send the search query to the selected search source;
generate a script that, when run by the client, causes the client to re-send the search query for a delayed search source, when the selected search source is an immediate search source; and
return the search results from the selected search source to the client via the communication interface.

16. The apparatus of claim 15, the federated search module comprising:
a search handler to select the search source from a search sources mapping configuration list and to format results for display by the client;
a search manager to select a search configuration for the selected search source; and
a search connector to generate a search configuration instance including the search query formatted according to the selected search source.

17. The apparatus of claim 16, the search manager further to aggregate search results from a plurality of search sources for the search handler and to format the search results for the search handler.

18. The apparatus of claim 16, wherein the search sources mapping configuration list is dynamically configurable to change an immediate search source to a delayed search source or a delayed search source to an immediate search source

19. The apparatus of claim 15, the federated search module further to send the script to the client with the search results when the selected search source was an immediate search source.

20. The apparatus of claim 15, wherein the search sources are independent of the apparatus.
